(19) United States
(12) Patent Application Publication
(10) Pub. No.: US 2005/0026668 A1
(43) Pub. Date: Feb. 3, 2005

(54) Sequential multi-hand poker game

(76) Inventor: Elia Rocco Tarantino, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/932,587

(22) Filed: Sep. 1, 2004

Related U.S. Application Data
(63) Continuation-in-part of application No. 10/434,980, filed on May 8, 2003.

(51) Int. Cl. G06F 17/00

(52) U.S. Cl. 463/13

(57) ABSTRACT

A poker game offers the play of multiple poker hands with large payoffs. In one embodiment, multiple hands of cards are generated. The outcome of the game is declared a winning outcome if successive hands have a higher rank than previous hands. In one embodiment, a winning outcome may also be declared if particular hands comprise predetermined winning ranks of cards. In another embodiment, groups of poker hands are generated and a winning result is declared if the highest rank of any of the cards of a successive group exceeds the highest rank of any of the hands of the previous group. Poker hands of the games may be generated stud or draw style.

### RELATED APPLICATION DATA

This application is a continuation-in-part of U.S. application Ser. No. 10/434,980, filed May 8, 2003.

### FIELD OF THE INVENTION

The present invention relates to card games and, more particularly, to poker-type card games.

### BACKGROUND OF THE INVENTION

Poker is a popular card game which has many variations of play. As is known, the game of poker has been adapted for play on electronic gaming devices commonly referred to as “video poker machines”. In the game of video poker, a player attempts to obtain a hand of cards which comprise one or more predetermined winning card combinations. For example, the winning card combinations may comprise a pair of Jacks or better. The player attempts to obtain a hand including cards of at least a pair of Jacks or better. If the player receives a winning hand, the player may be paid a payment. The game then ends.

In order to maintain the interest of players, a wide variety of game options have been presented. For example, in some games the amount which may be wagered varies. In other games, the hands which comprise predetermined winning hands vary.

One disadvantage to the game of video poker is that there is little opportunity for large payouts or jackpots. The largest payout is reserved for a Royal Flush. However, this card hand occurs infrequently. In most instances, if a player is a winner, he/she wins a small payout for a hand such as a Pair, Three of a Kind or the like.

It is desired to provide a poker game offering the player opportunities for higher stakes and winnings and which adds general excitement.

### SUMMARY OF THE INVENTION

The present invention comprises a method of playing a game. In one embodiment, the game is a poker-type game which involves the play of more than one hand of cards.

In one embodiment, the game includes the step of dealing a first set of cards which are used to form a first hand of cards. In one embodiment, the player has the opportunity to select none, one or more cards from the first set of cards to hold or discard. Replacement cards are provided for each discarded card. The held cards and any replacement cards are used to form the first hand.

The outcome of the first hand is a winning outcome if the rank of the first hand is a predetermined rank or is a predetermined combination of cards. The ranks may comprise, for example, Pairs above the rank of Jack, Three of a Kind, a Flush, a Straight or the like.

If the outcome of the first hand is a winning outcome, the player may elect to stop the game and receive any winnings. Alternatively, the player may elect to continue the game. If the player continues the game, the player attempts to achieve a second or next hand having a higher rank than the first or previous hand. If the player elects to continue, a next set of cards are dealt and are used to form a next hand. In one embodiment, the player is again allowed to draw and replace cards.

The rank of the second or next hand is determined. If the rank of the second or next hand is higher than that of the first or previous hand, then the outcome of the game is a winning outcome. If the outcome of the game is a winning outcome, in one embodiment the player may be permitted to continue playing unless the rank of the hand was the highest possible rank. In this version of the game, the player has the opportunity to play in seriatim, a plurality of hands, so long as each successive hand has a higher rank than the previous hand and until the highest rank hand is obtained.

In one embodiment of the invention, the game is played as a wagering game. A player places a wager for the possibility of being paid winnings. In this embodiment, a first paytable provides winnings for predetermined winning combinations or ranks of first hands. A second paytable is preferably applicable to the second hand, a third paytable is applicable to the third hand and so on. Preferably, the payouts for winning combinations for each paytable increase for each successive hand.

In a preferred embodiment, the game is presented on an electronically controlled machine. Images of cards are displayed to the player using a display.

A plurality of other variations of the game of the invention are also disclosed. In another embodiment, a player places a bet in order to be entitled to play a number of poker hands. Generally, the larger the bet, the greater the number of hands the player is permitted to play.

In another embodiment, a plurality of poker hands are generated and displayed to a player. A winning result is preferably declared if successive hands have higher rankings than previous hands. A winning result may also be declared for hands of the group which individually comprise predetermined winning rankings of cards. In one embodiment, the hands are generated stud (i.e. with no draw) style. In another embodiment, one or more of the hands may include a draw feature.

In another embodiment, at least a first and a second grouping of a plurality of poker hands is generated. A winning result is preferably declared if the highest ranked hand in a successive group is higher than the highest ranked hand of a previous group. The plurality of the hands of the groups may be formed in various manners.

Various additional embodiments of the invention are disclosed in which the multiple or successive hands of card are generated stud or draw style, and in which various criteria determine whether winnings results are obtained.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming device of the type which may be used to implement a game in accordance with the invention for play by a player;

FIG. 2 illustrates an exemplary first set of cards provided in accordance with a game of the invention;

FIG. 3 illustrates an exemplary set of cards held from the set of cards illustrated in FIG. 2;

FIG. 4 illustrates an exemplary first hand after replacement cards have been provided, as well as winnings associated with a first paytable applicable to the first hand;

FIG. 5 illustrates an exemplary second set of cards;

FIG. 6 illustrates an exemplary set of cards held from the second set of cards illustrated in FIG. 5.

FIG. 7 illustrates an exemplary second hand after replacement cards have been provided, as well as winnings associated with a second paytable applicable to the second hand;

FIG. 8 illustrates an example of play including a third hand;

FIG. 9 is a flowchart illustrating an exemplary method of the invention;

FIG. 10 illustrates a multi-hand version of the game of the invention;

FIG. 11 illustrates another example of a multi-hand version of the game of the invention; and

FIG. 12 illustrates yet another multi-hand version of the game wherein multiple groupings of a plurality of poker hands are utilized.

### DETAILED DESCRIPTION OF THE INVENTION

The invention is a method of presenting and playing a game. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises a method of playing a poker-type card game. In general, a plurality of poker hands are generated. The object of the game is to obtain successive poker hands having higher ranks than previous poker hands. In one embodiment, the hands are played in seriatim, the player starting with a first hand and then electing to play additional hands. In other embodiments, multiple hands are presented at the same time. In yet other embodiments, hands are presented or played in groups.

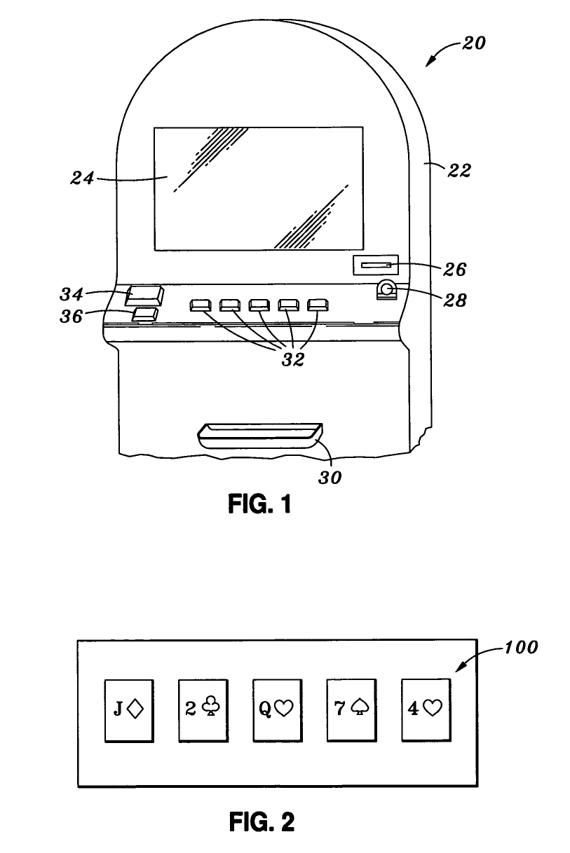

In a preferred embodiment, games of the invention are presented to a player with a gaming machine. FIG. 1 illustrates a gaming machine 20 in accordance with the invention. As illustrated, the gaming machine 20 includes a housing 22 for enclosing/supporting various components of the gaming machine. The gaming machine 20 includes a display 24 for displaying images of cards or other indicia. Speakers (not shown) or other devices may be provided for generating sound associated with the game.

In one embodiment, the game is played as a wager-type game which requires that a player place a bet or wager to play the game. Preferably, if the player is a winner of the game, then the player is provided an award, such as a monetary payout (such as coins) or other prizes. As illustrated, the gaming machine 20 may include a bill validator/acceptor 26 for accepting paper currency and a coin acceptor 28 for accepting coins. Other means of payment, such as a credit card reader, may be provided. An award of winnings in the form of coins may be paid to the player via a coin tray 30.

Preferably, the gaming machine 20 includes means for a player to provide input. In one embodiment, this means comprises one or more buttons. For example, a plurality of card “hold” or “select” buttons 32 may be provided for permitting a player to hold/select cards in a hand. A deal/draw button 34 permits a player to indicate that he/she wishes the game to start or to draw replacement cards. A bet button 36 is provided for a player to select the amount to bet on a particular game.

A game controller (not shown) is provided for controlling the various devices of the gaming machine and for providing game information. For example, the game controller may be arranged to generate video and audio data for presentation by the display and speakers of the gaming machine 20. The game controller may be arranged to detect a signal from the coin acceptor indicating the receipt of coins, and may be arranged to cause a coin delivery mechanism to deliver coins from a coin hopper to the coin tray 30.

It will be appreciated that the gaming machine 20 may have a variety of configurations, and that the gaming machine 20 illustrated and described above is but an example of a device for implementing the game of the present invention. In one or more embodiments, the gaming machine 20 may be associated with a network and receive game information remotely and may transmit information, such as payout and game play information, to a remote location. It will also be appreciated that the games of the invention may be presented or played as table games, such as with real cards.

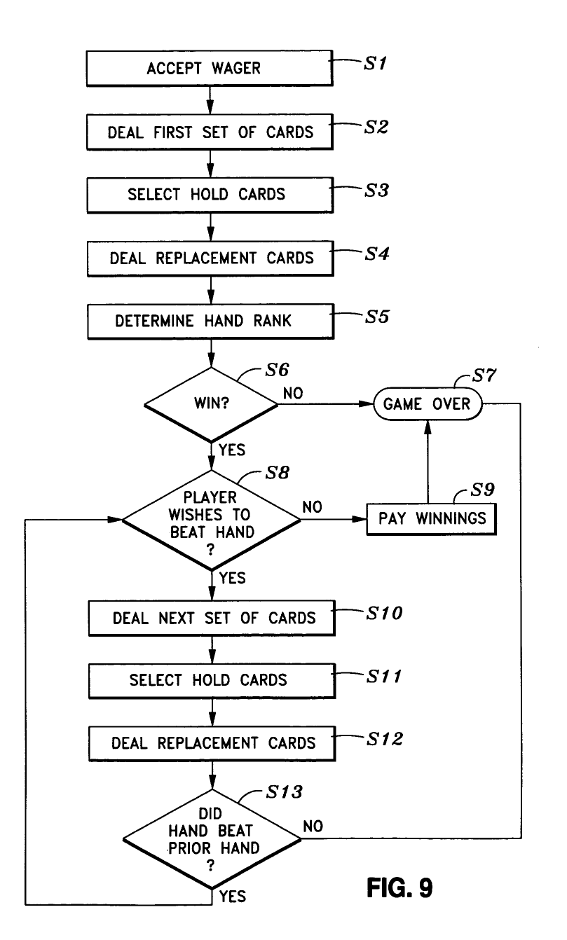

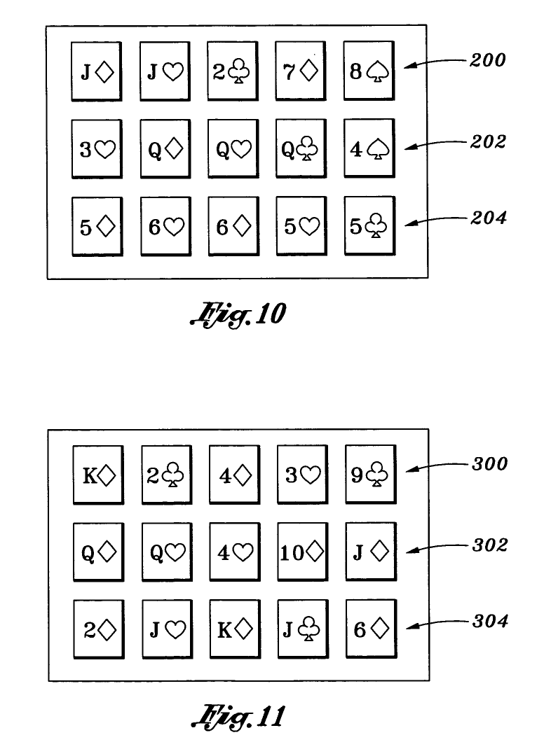

One embodiment of a game in accordance with the present invention will be described with reference to FIGS. 2-9. One sequence of steps comprising a method of game play is illustrated in FIG. 9. Exemplary outcomes of those steps are illustrated in FIGS. 2-8, it being understood that a variety of other outcomes may result. Preferably, the game is presented at a gaming machine such as that illustrated in FIG. 1.

In a preferred embodiment, the game of the invention is played as a “wager” type game. In this form, as illustrated in step S1 of FIG. 9, a player places a wager or bet. The wager or bet may comprise money, such as coins or currency, or one or more elements representative of value, such as credits. The wager or bet may be placed in a variety of fashions, such as by inputting coins to the coin acceptor 28 or one or more bills to the bill validator 26. As is known, when a player provides monetary value, that value may be represented as credits on the gaming machine 20. The player may then utilize those credits to place the wager or bet.

In a step S2, a set or hand of cards is dealt for use in playing a game. Preferably, as illustrated in FIG. 2, a set of five cards 100 is dealt. The set of cards 100 is preferably selected from a single deck of cards, though the cards may be selected from other sets of cards, such as multiple decks of cards.

As illustrated, the set of cards 100 is preferably dealt face up for viewing by the player. One or more of the cards may be dealt face-down and then turned over. In one embodiment, the cards may be dealt at one time or at different times. When played on a gaming machine, images of the cards are preferably generated and displayed on the display. The cards which are displayed may be selected using a random number generator, as is known to those of skill in the art.

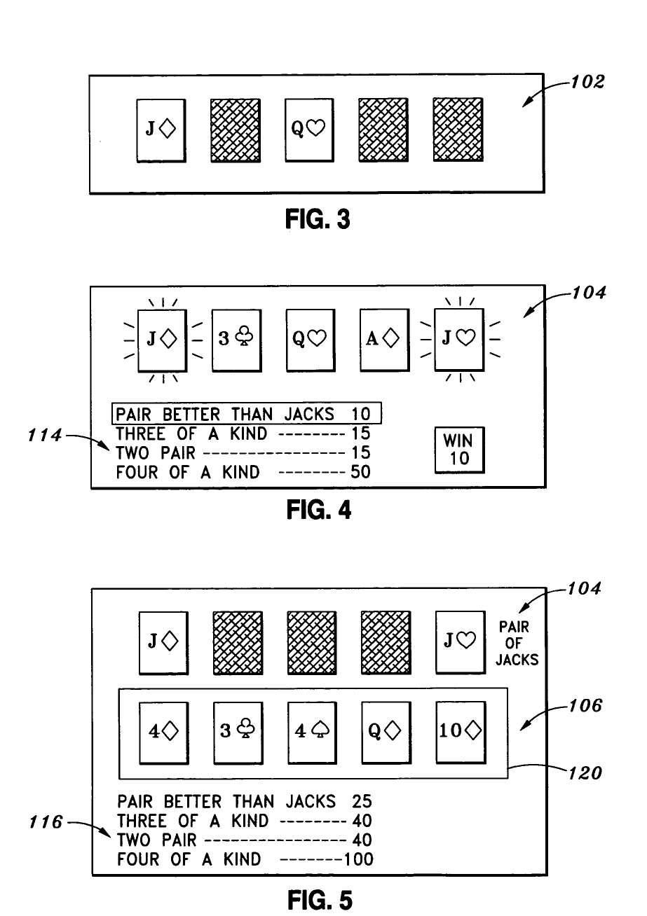

Referring to FIG. 9, in a step S3 in one embodiment, the player is permitted to discard one or more cards from the set of dealt cards 100. The player may make selections of cards to discard, or may make selections of cards to hold and have the un-held cards discarded. In one embodiment, the player may select none, one or more, or all of the cards to hold or discard. The player's selections may be input by various means, such as by touch-screen or by depressing “hold” or “discard” buttons. As illustrated in FIG. 3, after the player has made his/her hold/discard selections, a set of held cards 102 remains.

Referring again to FIG. 9, in a step S4, replacement cards are dealt or provided for each discarded card. In one embodiment, the replacement card or cards are selected from the same set of cards as the original set of cards 100. If a single deck of cards is being used, the replacement cards are preferably dealt from that same deck of cards. After replacement cards are dealt, if any, the remaining cards comprise a player's hand 104, as illustrated in FIG. 4.

Referring to FIG. 9, in a step S5, the rank of the hand is determined. In other words, it is next determined if the combination of cards comprising the hand is a winning combination of cards. Preferably, the hand is a winning hand if the combination of cards comprises one of a predetermined set of winning ranks or combinations. In one embodiment, those predetermined winning ranks or combinations are those commonly used in the game of Poker, such as Two Pair, Three of Kind, a Full House, a Royal Flush and the like. Of course, the particular predetermined winning combinations may vary. For example, a hand including a single Pair may be winning only if the Pair comprises Jacks or better.

In a step S6, if the hand is not a winning hand, then in a step S7, the game is over. In the event the game is being played as a wager type game, the player preferably loses his/her wager or bet.

If in step S6 the hand is determined to be a winning hand, then in a step S8, it is determined whether the player wishes to continue the game by attempting to beat his/her hand. If in this step the player does not wish to continue the game, then in a step S9, the player is preferably paid any winnings or is awarded any award resulting from the winning outcome. For example, in a preferred embodiment of the game, the player places a bet or wager for the opportunity, if a winning result is obtained, to be paid winnings. The winnings may comprise money or other value. After any winnings are paid, the game ends at step S7.

In step S8, the player may elect to continue the game. In a preferred embodiment, continued game play comprises one or more sequential attempts to beat the prior poker hand. In one embodiment, in order to continue the game, the player is not required to place an additional wager, but instead the player's original wager or bet and the amount won as a result of playing the first hand are utilized as the bet.

If the player elects to continue the game, in a step S10, a next set of cards is dealt. FIG. 5 illustrates an exemplary next set of cards 106. As also illustrated in FIG. 5, the original winning hand 104 may be displayed to the player. This aids in identifying for the player the rank of the hand that he/she is trying to beat.

The next set of cards 106 is preferably dealt in the same fashion as the original hand of cards. In one embodiment, the next set of cards 106 is dealt from a new deck or set of cards separate from the first hand of cards 102. In another embodiment, the cards are dealt or provided from the same deck or set of cards from which the previous cards were dealt or provided.

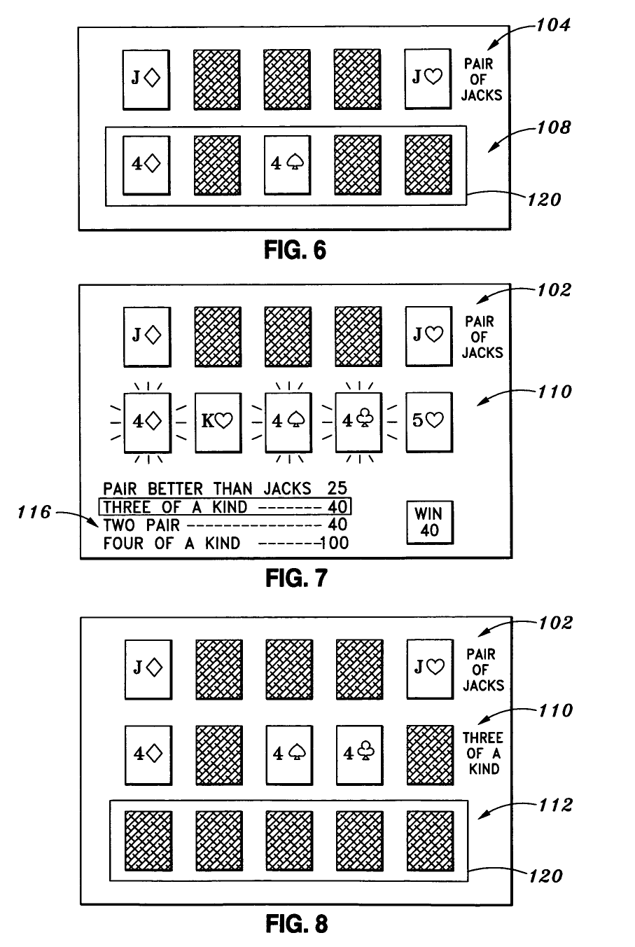

Referring again to FIG. 9, in a step S11 the player preferably has the opportunity to select one or more cards to hold or discard. After the player makes such selections, the player has a set of held cards. FIG. 6 illustrates an exemplary set of held cards 108 after a player made card selections from the next hand of cards 106 illustrated in FIG. 5.

Referring again to FIG. 9, in a step S12 a replacement card is dealt for each card which is discarded or not held in order to complete a next hand of cards. FIG. 7 illustrates an exemplary next hand of cards 110 after replacement cards have been provided.

Referring to FIG. 9, in a step S13 it is determined if the next hand of cards beat the previous hand of cards. This step preferably comprises determining the rank of the next hand of cards and determining if that rank is higher than the rank of the previous hand of cards. If not, then the game ends at step S7. If the game ends in this fashion, the player is preferably paid no winnings.

If the next hand beat the previous hand, then the player is provided the option to continue the game in step S8. If the player does not wish to continue the game, any winnings are paid in step S9, and the game then ends at step S7. If so, then in step S10, the next set of cards is dealt.

In one embodiment, this sequence of play in which a player has the opportunity to beat his/her prior hand may continue until the player has received the highest possible hand rank, at which time the game preferably ends automatically and the player is paid winnings, since the player then no longer has the opportunity to achieve a higher-ranking hand.

FIG. 7 illustrates an exemplary next hand of cards 110. As illustrated, this next hand of cards 110 comprises includes three (3) Fours, or a Three of a Kind. In one embodiment, winning hands are ranked in accordance with normal poker rules. Of course, other rankings might be provided. In accordance with the embodiment illustrated, a Three of a Kind beats a Pair. As a result, the next hand of cards 110 beats (i.e., has a higher rank than) the previous hand 104. As such, the player has won the game.

FIG. 8 illustrates an exemplary embodiment of the game where, after winning the second hand, the player has elected to continue to play a next hand. As illustrated, the cards comprising the winning cards of the first hand 104 and second hand 110 are illustrated for the player's convenience. Card locations 112 are illustrated for the next set of cards to be dealt.

In accordance with one embodiment of the invention, the player has an opportunity to win significant payouts or jackpots as a result of the game play. FIG. 4 illustrates a partial paytable 114 for winnings paid for particular hands or hand ranks for the first hand of play. As illustrated, this paytable may utilize generally accepted payouts for video poker hands. In this instance, if a player has placed a wager or bet of 10 credits, the player is paid even money, or 10 credits, for a Pair comprising Jacks or better. Of course, the paytable may include payouts for a variety of other hands or ranks.

In accordance with the present invention, the player has the opportunity to win a payout or jackpot for beating his/her own hand. This paytable preferably reflects the risk associated with the player foregoing his/her previous winnings and attempting to achieve a higher hand. FIG. 5 illustrates an exemplary paytable 116 for a second or next winning hand which beats the prior hand. As illustrated, the payout for a Pair with a rank greater than the player's previous winning hand of a Pair of Jacks (i.e., a Pair of Queens or better) pays 25 credits. Notably, this is greater than the sum of the player's foregone winnings (10 credits). Preferably, the paytable continues to change for each successive hand played by the player, with the payouts for winning hands increasing greatly.

Various alternate configurations of the invention and other features are contemplated within the scope of the invention.

The game of the invention can be implemented by playing variations of poker. For example, the game could be played stud-style, such as Five Card Stud or Seven Card Stud poker. In the case of Five Card Stud, five cards may be dealt to the player and those cards would comprise the player's hand. The player would not be permitted to draw and replace any cards. In the case of Seven Card Stud, seven cards may be dealt to the player and the player may be permitted to select five cards from the seven to comprise his/her hand. The hands could also be generated using house or common cards. For example, all hands might be formed using the same common cards (such as two or three common cards) and additionally dealt or drawn cards.

Several of such embodiments of the game of the invention will now be described in more detail. In one embodiment of the invention, the game is played as multiple hand stud type game. One example of such a game will be described with reference to FIG. 10.

Once again, the game is preferably played as a wagering type game. In one embodiment, the number of hands which are presented for play is determined by the size of the player's wager. In another embodiment, the size of the wager impacts only the amount of winnings awarded.

As illustrated in FIG. 10, in accordance with the method of play, at least two, and preferably three or more poker hands are presented to a player. In the preferred embodiment, each hand is presented in “stud” form, in which the complete hand of five cards is generated and then displayed to the player. As illustrated, a first hand 200, a second hand 202 and a third hand 204 are displayed.

Preferably, a winning outcome is declared and winnings are paid to the player in the event the poker hand ranking of one or more of the hands is higher than that of a previous hand. As illustrated, for example, the first hand 200 rank is a pair of Jacks. The second hand 202 rank is Three of a Kind. Because the rank Three of a Kind is higher than, or beats, a pair of Jacks, a winning outcome is declared as to the second hand. Similarly, the third hand 204 rank is a Full House. Because the rank Full House is higher than, or beats, a Three of Kind, a winning outcome is declared as to the third hand.

In this embodiment, winnings are preferably paid to the play because the second hand 202 “beat” (i.e. had a higher rank) than the first hand 200. Winning are preferably also paid to the player because the third hand 204 “beat” (i.e. had a higher rank) than the second hand 202.

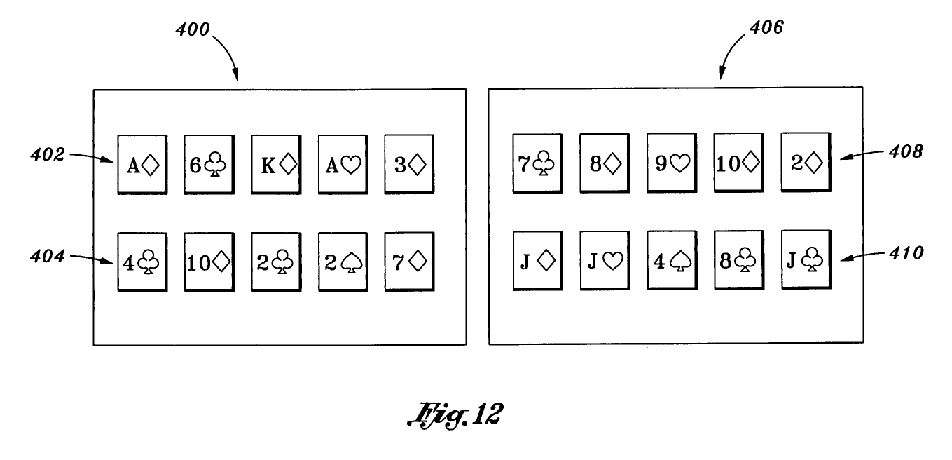

In one embodiment of the game, a player may additionally be awarded an award when the first hand 200 comprises a predetermined winning combination, or for each hand which comprises a predetermined winning combination. For example, winnings may be awarded for each hand where the hand comprises at least a pair of Jacks or better. For example, referring to FIG. 11, there is display a first poker hand 300, a second poker hand 302, and a third poker hand 304. The third poker hand 304 has a lower rank than the second poker hand 302, and thus did not “beat” that previous hand. However, the player may be awarded winnings because the third hand 304 still independently comprised a winning combination of cards (a pair of Jacks in this instance). In addition, winnings may be awarded when one hand beats a prior hand. These winnings may be the same or different than the winnings awarded for winning hands.

As described above, in one embodiment, a player must receive a winning first hand in order to be entitled to continue to play a successive hand. In another embodiment, winnings are paid to a player when each successive hand has a higher rank than the previous hand, regardless of whether the hand or hands comprise winning combinations of cards. For example, winnings may be paid for each hand which comprises at least a pair of Jacks or better, or other combinations of cards. However, winnings may be additionally paid even if such combinations of cards are not received, so long as the hands are successively of higher rank.

Such an embodiment is illustrated in FIG. 11. As illustrated therein, the first hand 300 has a rank of King high. This hand may not comprise a winning hand. However, the player may be entitled to play additional hands, either in the “draw” format described above, in “stud” format or in other formats. In this case, a second stud hand has been generated and displayed and comprises a pair of Queens. Because this hand has a higher rank than the first hand, a winning result may be declared and the player may be awarded winnings.

In one embodiment, a winning result is declared only for each successively higher ranked hand starting with the first and second hands. In other words, if the second hand is not of a higher rank than the first hand, then a winning result is not declared even if the third hand is a higher rank than the second or first hand. In another alternate embodiment, winning results could be declared in such situations.

A great number of variations of play of the game of the invention, including the specific embodiments described above, are contemplated.

In one embodiment, the cards used in the game are dealt from the same deck (either actual or simulated deck). This variation is preferred in the “stud” version of the game in which all of the hands are generated and displayed without a draw. In particular, when all of the hands of cards are dealt from the same deck, the probabilities of obtaining successively higher ranking hands is diminished as cards are used in prior hands. As a result, the winning payouts which may be awarded for “winning” second, third or additional higher ranked hands may be extremely large. These payout may be jackpot sized, resulting in great enticement to the player to play the game.

In one embodiment, the size of an award or winning for a successively higher ranked hand may vary depending upon the rank of the prior hand. For example, if the successive hand beats a prior hand of a Pair, then a first award may be paid. If the successive hand beats a prior hand of a Four of a Kind, then a second award may be paid. Of course, the payouts may increase linearly or non-linearly.

In one embodiment, the first hand may be treated as “base” hand, and not be entitled to payment for any winning result. In one embodiment, a player places a wager regarding whether the second hand (or additional successively hands) will be the first hand and/or whether the second hand (or additional successive hands) are winning combinations themselves. Thus, even if the first hand were a Full House or other hand which might otherwise be a winning combination, no winnings are awarded.

As one variation, some hands may be dealt as stud hands, while one or more other hands may be dealt and played with a draw feature. In one example, a player may play a first hand as a “draw” hand. After completion of the first hand, the second and any additional hands may be generated and displayed in “stud” form. In one embodiment of this variation, the player may, as described above, place a first wager or bet to play the first hand. The player may then be given the opportunity to play one or more additional hands if an additional wager is placed. In another embodiment, the first hand may be dealt as a stud hand and then later hands dealt as draw hands, providing the player the opportunity to try and play a strategy for obtaining a winning hand which beats the prior hand.

In one embodiment which is especially applicable to variations of the game where a “draw” feature is enabled, the active hand may be highlighted to the player, as illustrated in FIGS. 5, 6 and 8 by the active box 120. This is especially useful when the previous hand(s) is displayed to the player while a later hand is being played. Of course, other means may be used to indicate to the player which set of cards or hand is active.

The game may be played as a non-wagering game for entertainment purposes or for the right to win payouts or prizes. In such event, the player may not be required to place a wager or bet. The player may still be paid winnings, if desired, for winning outcomes. In one embodiment, the player may have the opportunity to win credits which have no monetary value. Those credits may simply be used to indicate the relative success of the player in playing the game, or may be redeemed for prizes or the like. The game may also be played for points or other value other than credits or direct monetary value representation. In one embodiment, the player may be required to pay a fee to play the game, even though the fee is not called a wager.

As illustrated, the game is preferably presented as a video poker type game at an electronic gaming machine, whether configured as a computer, mobile device, or specifically configured machine. The game could be played using physical cards, such as dealt at a table.

In one embodiment, if a next or successive hand of the game has the same rank as the previous hand, then the outcome of the game is a losing outcome, i.e., the next hand did not beat the previous hand. For example, the outcome of the game may be a losing outcome if the second hand rank is a Pair of Jacks and the outcome of the first hand rank is a Pair of Jacks.

In another embodiment, if the outcome of the next or successive hand and the previous hand is the same rank, then the outcome may be neither a win or loss. Instead, the player may be permitted to play another “next” hand over in an attempt to beat the previous hand or the player may be permitted to stop the game and be paid the winnings associated with the previous winning hand or hands.

In one embodiment, winnings may accumulate. For example, if the player obtains a winning first hand, the player may be awarded a first winning amount. If the player obtains a losing second hand, then the first winning amount may be lost. If the player obtains a winning second hand, then the player may be awarded a second winning amount. The player may then quit the game and be awarded both the first and second winning amounts or continue the game.

In one embodiment, aspects of the invention could be applied to play of sets or groups of hands. For example, a player might place a bet entitling the player to play two or more hands. The hands may be generated in a variety of manners, including by being dealt in “stud” format or including a “draw” feature. As to a first set of hands, a hand having the highest rank is identified. As described above, if the hands of the set do not comprise any winning combinations of cards, the game may end. In other embodiment, the game may continue either automatically or by the player placing an additional wager, regardless of the rank of the hands of the first set.

Next, a second set or group of hands are generated. The object for the player is to obtain at least one hand in the second set of cards which has a higher rank than the rank of the highest hand(s) in the first set. For example, FIG. 12 illustrates an embodiment where a first set of cards 400 comprising a first hand 402 and a second hand 404 have been generated. The highest ranking hand is the first hand, 402 with a pair of Aces. The player has played a second set of cards 406 comprising a first hand 408 and a second hand 410. In this case, the highest ranking hand of the second set of cards 406, the second hand 410 comprising Three of a Kind, has a higher rank than the highest ranking hand of the first set of cards. As a result, a winning result may be declared and the player may be awarded winnings. Of course, the method of play could continue to include successive sets or groups of cards.

In one embodiment, the first set of cards could be re-used when playing subsequent hands. For example, if the player has received a winning first hand, the first set of cards may again be re-displayed and used in forming the next hand. The player may again select cards to hold/discard from the set of cards and then attempt to form a higher hand using the held cards from the first set of cards and any replacement cards. For example, the hands may be generated utilizing the methods described in U.S. Pat. Nos. 6,474,645 and 5,823,873 which are incorporated herein by reference.

The aspects of these methods of play are particularly applicable to the embodiment of the game just described and illustrated in FIG. 12. In this embodiment, the hands of each set may be generated in accordance with these methods, with the player attempting to obtain, especially in the case of the second set of cards, one or more hands in the successive sets which are of progressively higher rank.

The game of the invention has numerous advantages. First, the game is an exciting poker type game involving the potential to play more than a single hand. The game offers the player the opportunity to play multiple hands during a single game.

In the case of the “stud” variation of the game, the game offers high speed play of an exciting game offering large payouts. In the case of the “draw” variation of the game, the game offers the player opportunity to employ substantial strategy in game play, lending intellectual excitement to the game.

In addition, the game offers the player the opportunity for large payouts. In current video poker game play, the payouts for a single hand are restricted by the amount of the bet and the single set of odds for receiving particular outcomes. In the present invention, large payouts are available because of the odds associated with not only receiving particular winning hands, but hands which sequentially are higher than previous hands.

It will be understood that the above described arrangements of apparatus and the method therefrom are merely illustrative of applications of the principles of this invention and many other embodiments and modifications may be made without departing from the spirit and scope of the invention as defined in the claims.

1. A method of presenting a game on an electronic gaming device to a single player comprising the steps of:
accepting from the player a wager to play the game;
generating a first poker hand of cards;
generating a second poker hand of cards;
comparing the rank of the second poker hand of cards to the rank of the first poker hand of cards; and
declaring a winning outcome if the rank of the player's second poker hand of cards is higher than the player's first hand of poker cards.

2. The method in accordance with claim 1 including the steps of generating a third poker hand of cards and declaring a winning outcome if a rank of the third poker hand of cards is higher than the rank of the second poker hand of cards if a winning outcome was declared as to the comparison of the player's second poker hand of cards to the player's first hand of cards.

3. The method in accordance with claim 1 wherein said step of generating a first poker hand of cards comprises generating a set of five cards and displaying those cards to the player and wherein said step of generating a second poker hand of cards comprises generating a second set of five cards and displaying the second set of five cards to the player.

4. The method in accordance with claim 3 wherein said first and second sets of cards are displayed substantially simultaneously.

5. The method in accordance with claim 3 wherein said first and second sets of cards are generated from the same set of cards comprising a single deck of cards.

6. The method in accordance with claim 1 wherein said step of generating said first poker hand of card comprises dealing a first set of cards; accepting selection from said player of one or more of said cards to hold; discarding cards not selected to be held and providing a replacement card for each discarded card.

7. The method in accordance with claim 1 wherein said step of generating said second poker hand includes the step of accepting selection from said player of one or more cards from said first hand to be used in said second hand.

8. The method in accordance with claim 1 including the step of paying a winning if a winning outcome is declared.

9. The method in accordance with claim 8 including the step of determining of said first poker hand of cards comprises a predetermined winning combination of cards and, if so, declaring a winning result and paying a winning outcome.

10. The method in accordance with claim 9 including the step of determining if said second poker hand of cards comprises a predetermined winning combination of cards and, if so, declaring a winning result and paying a winning outcome.

11. A method of presenting a game on an electronic gaming device comprising the steps of:
generating a first grouping of poker hands comprising at least two poker hands;
generating a second grouping of poker hands comprising at least two poker hands; and
declaring a winning result of said game if at least one of the poker hands of said second grouping has a higher rank than the highest ranking of any of the poker hands of said first grouping.

12. The method in accordance with claim 11 including the step of accepting a wager from a player and wherein said steps of generating said first and second groupings of poker hands comprises displaying card images on a video display.

13. The method in accordance with claim 11 wherein said steps of generating said first and second groupings of poker hands comprise generating stud poker hands.

14. The method in accordance with claim 11 wherein said steps of generating said first and second groupings of poker hands comprise, as to one or more of said hands, displaying cards to a player, permitting said player to discard one or more or all of the displayed cards and dealing replacement cards for displayed cards to form a poker hand.

15. A method of presenting a game comprising the steps of:
generating a first poker hand of cards;
generating a second poker hand of cards;
declaring a first winning result if either of said hands of cards comprises a predetermined winning combination of cards; and
declaring a second winning result if a rank of said second poker hand of card is higher than a rank of said first poker hand of cards.

16. The method in accordance with claim 15 wherein said first poker hand of cards is generated stud style.

17. The method in accordance with claim 16 wherein said second poker hand of cards is generated draw style.

18. The method in accordance with claim 15 wherein said first and second poker hands of cards are generated stud style.
